(19) United States
(12) Patent Application Publication
(10) Pub. No.: US 2014/0055854 A1
(43) Pub. Date: Feb. 27, 2014

(54) OPTICAL SHEET AND DISPLAY DEVICE

(71) Applicant: Dai Nippon Printing Co., Ltd., Tokyo (JP)

(72) Inventors: Fumihiro ARAKAWA, Shinjuku-Ku (JP); Takashi KURODA, Shinjuku-Ku (JP); Kohei KOMIZO, Shinjuku-Ku (JP)

(73) Assignee: Dai Nippon Printing Co., Ltd., Tokyo (JP)

(21) Appl. No.: 13/903,277

(22) Filed: May 28, 2013

(30) Foreign Application Priority Data
May 29, 2012 (JP) 2012-122294

(51) Int. Cl. G02B 27/26; G02B 5/30

(52) U.S. Cl. CPC G02B 27/26; G02B 5/3083
USPC 359/462; 359/489.11

(57) ABSTRACT

An optical sheet (40) is used in a display device for switchably displaying a two-dimensional image and a naked-eye visible three-dimensional image. The optical sheet (40) includes: a first layer (51) including a thermoplastic resin; and a second layer (52) laminated to the first layer. The first layer is an optically anisotropic An optical interface (55) for changing the traveling direction of light of one polarization component is formed between the first layer (51) and the second layer (52).

### CROSS-REFERENCE TO RELATED APPLICATION

This application claims priority to Japanese Patent Application No. 2012-122294, filed on May 29, 2012, the disclosure of which is incorporated herein by reference in its entirety.

### BACKGROUND OF THE INVENTION

1. Field of the Invention

The present invention relates to a display device for switchably displaying a two-dimensional image and a naked-eye visible three-dimensional image, and to an optical sheet for use in the display device and for controlling the traveling direction of light depending on the polarization state of the light.

2. Description of the Related Art

A display device which displays three-dimensional images that can be viewed with the naked eye has been developed, as disclosed e.g. in WO 03/015424 A2. Such a display device is configured to be capable of switching between a two-dimensional image formed on a display surface and a three-dimensional image, having a sense of depth, which can be viewed also at a position at a distance from the display surface.

In the display device disclosed in WO 03/015424 A2, a two-dimensional image is formed by one linear polarization component, while a three-dimensional image is formed by the other linear polarization component. The display device has a birefringent lens which exerts a lens function only on light of the other linear polarization component that forms a three-dimensional image. Light of the other linear polarization component, emitted from a pixel for forming a left-eye image, is focused by the birefringent lens on the left-eye position of a viewer. Similarly, light of the other linear polarization component, emitted from a pixel for forming a right-eye image, is focused by the birefringent lens on the right-eye position of the viewer. Consequently, the viewer views the left-eye image with the left eye while viewing the right-eye image with the right eye. The viewer can thus visually perceive a three-dimensional image.

The birefringent lens has an optically anisotropic layer and an optically isotropic layer, disposed adjacent to each other.

The refractive indices of the optically anisotropic layer and the optically isotropic layer are the same in the direction of vibration of one linear polarization component (polarized direction of one linear polarization component) and are different in the direction of vibration of the other linear polarization component (polarized direction of the other linear polarization component). Accordingly, only light of the other linear polarization component changes its traveling direction at the interface between the optically anisotropic layer and the optically isotropic layer.

The optically anisotropic layer of the birefringent lens exhibits optical anisotropy due to the presence of an oriented liquid crystal material in the layer. Because of the presence of the liquid crystal material, the birefringent lens lacks stability, especially thermal stability. This imposes restrictions on the environment in which the birefringent lens is used and on the environment in which a display device having the birefringent lens is installed.

### SUMMARY OF THE INVENTION

The present invention has been made in view of the above situation in the related art. It is therefore an object of the present invention to improve stability of an optical sheet for controlling the traveling direction of light depending on the polarization state of the light.

In order to achieve the object, the present invention provides a first optical sheet, said sheet comprising:

a first layer including a thermoplastic resin, the first layer being optically anisotropic; and

a second layer which is laminated to the first layer and which forms, between it and the first layer, an optical interface for changing a traveling direction of light of one polarization component,

wherein the optical sheet controls a traveling direction of light depending on a polarization state of the light and is used in a display device for switchably displaying a two-dimensional image and a naked-eye visible three-dimensional image.

In the first optical sheet according to the present invention, a material of the first layer may have a glass transition temperature of not less than 100° C.

The present invention also provides a second optical sheet, said sheet comprising:

an optically anisotropic first layer; and

a second layer which is laminated to the first layer and which forms, between it and the first layer, an optical interface for changing a traveling direction of light of one polarization component,

wherein a material of the first layer may have a glass transition temperature of not less than 100° C., and

wherein the optical sheet controls a traveling direction of light depending on a polarization state of the light and is used in a display device for switchably displaying a two-dimensional image and a naked-eye visible three-dimensional image.

The present invention also provides a third optical sheet, said sheet comprising:

an optically anisotropic first layer; and

a second layer which is laminated to the first layer and which forms, between it and the first layer, an optical interface for changing a traveling direction of light of one polarization component,

wherein the first layer contains no liquid crystal, and

wherein the optical sheet controls a traveling direction of light depending on a polarization state of the light and is used in a display device for switchably displaying a two-dimensional image and a naked-eye visible three-dimensional image.

In any one of the first to third optical sheets according to the present invention, the thermoplastic resin may be a polyethylene naphthalate resin.

In any one of the first to third optical sheets according to the present invention, an in-plane birefringent index Δn of the first layer may be not less than 0.13.

In any one of the first to third optical sheets according to the present invention, light of the other polarization component, traveling in a normal direction of the optical sheet before entering the optical sheet, may travel in a direction at an angle of not more than 2 degrees with respect to the normal direction of the optical sheet after passing through the optical sheet.

In any one of the first to third optical sheets according to the present invention, a dimensional stability of the optical sheet, measured according to JIS C2151 using a heating conditions of 150° C., 30 minutes, may be not more than 2%.

In any one of the first to third optical sheets according to the present invention, the second layer may be optically isotropic.

In any one of the first to third optical sheets according to the present invention, an electric dipole moment of the first layer may be higher than an electric dipole moment of the second layer.

In any one of the first to third optical sheets according to the present invention, the first layer may consist only of the thermoplastic resin.

The present invention also provides a display device, comprising:

the optical sheet according to claim 1; and

an image display unit disposed opposite to the optical sheet and configured to be capable of emitting light of one polarization component for forming a three-dimensional image and light of the other polarization component for forming a two-dimensional image,

wherein the display device switchably displays a two-dimensional image and a naked-eye visible three-dimensional image.

The present invention also provides a first method for producing a optical sheet, said method comprising the steps of:

producing an optically anisotropic first layer by stretching a resin film made by shaping a thermoplastic resin; and

producing or laminating a second layer on or to the first layer,

wherein the optical sheet controls a traveling direction of light depending on a polarization state of the light and is used in a display device for switchably displaying a two-dimensional image and a naked-eye visible three-dimensional image.

The present invention also provides a second method for producing a optical sheet, comprising the steps of: stretching a first layer and a second layer, the first layer and the second layer are laminated to each other,

wherein an electric dipole moment of the first layer is higher than an electric dipole moment of the second layer.

The present invention makes it possible to improve stability of an optical sheet which controls the traveling direction of light depending on the polarization state of the light.

### BRIEF DESCRIPTION OF THE DRAWINGS

FIG. 1 is a schematic perspective view of a display device, illustrating one embodiment of the present invention;

FIG. 2 is a vertical sectional view of the display device of FIG. 1, illustrating the path of light that forms an image when displaying a three-dimensional image by means of the display device;

FIG. 3 is a vertical sectional view of the display device of

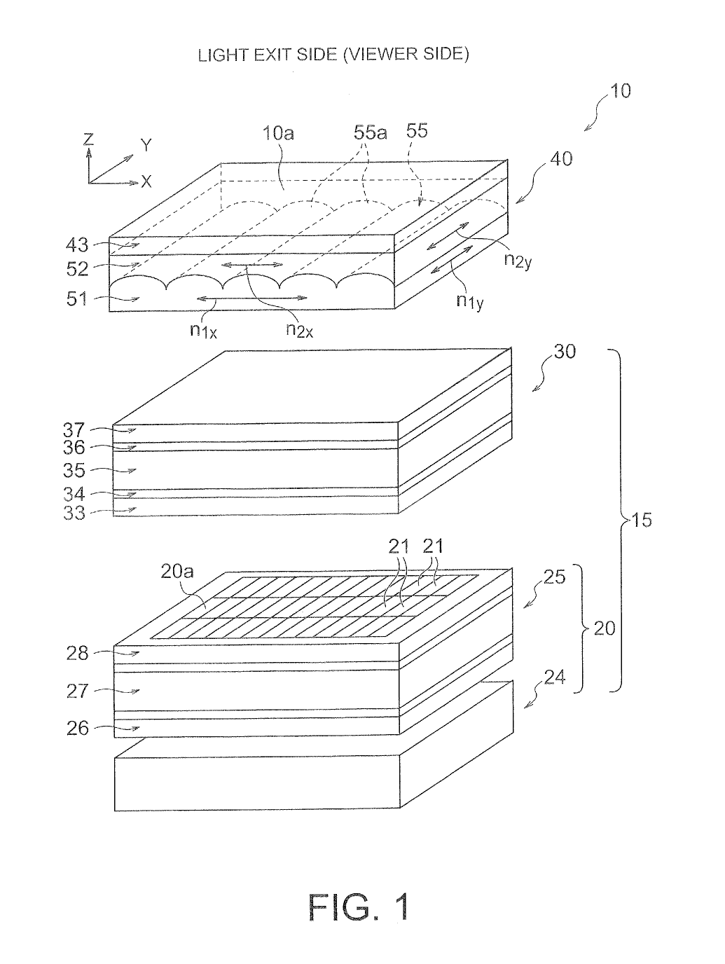

FIG. 1, illustrating the path of light that forms an image when displaying a two-dimensional image by means of the display device;

FIG. 4 is a perspective view showing the refractive index ellipsoids of the first layer and the second layer of an optical sheet incorporated in the display device of FIG. 1;

FIG. 5 is a diagram illustrating a method for producing an optical sheet; and

FIG. 6 is a diagram illustrating another method for producing an optical sheet.

### DETAILED DESCRIPTION OF THE PREFERRED EMBODIMENTS

Preferred embodiments of the present invention will now be described with reference to the drawings. In the drawings attached to the present specification, for the sake of illustration and easier understanding, scales, horizontal to vertical dimensional ratios, etc. are exaggeratingly modified from those of the real things.

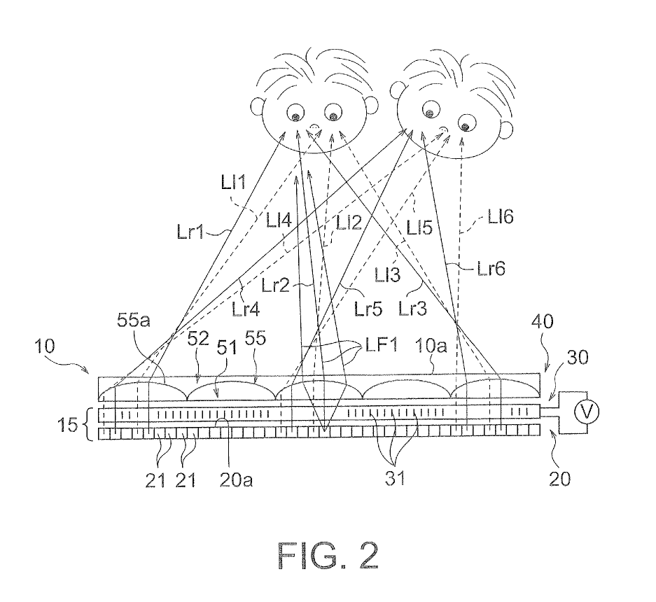

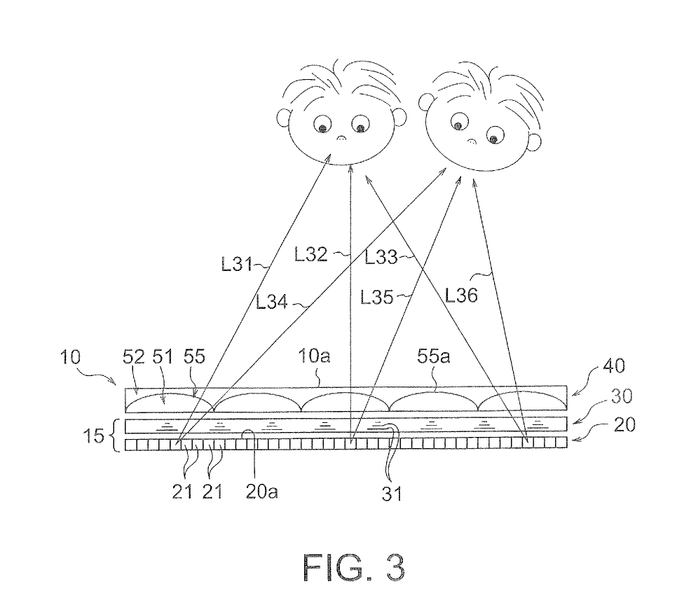

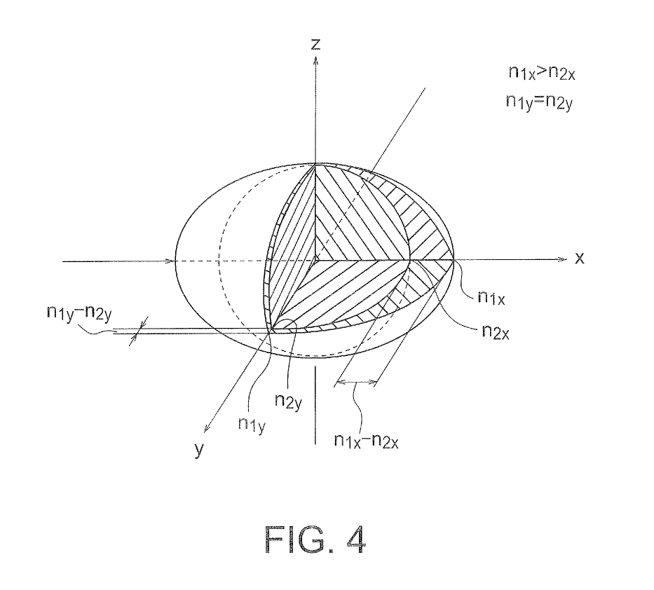

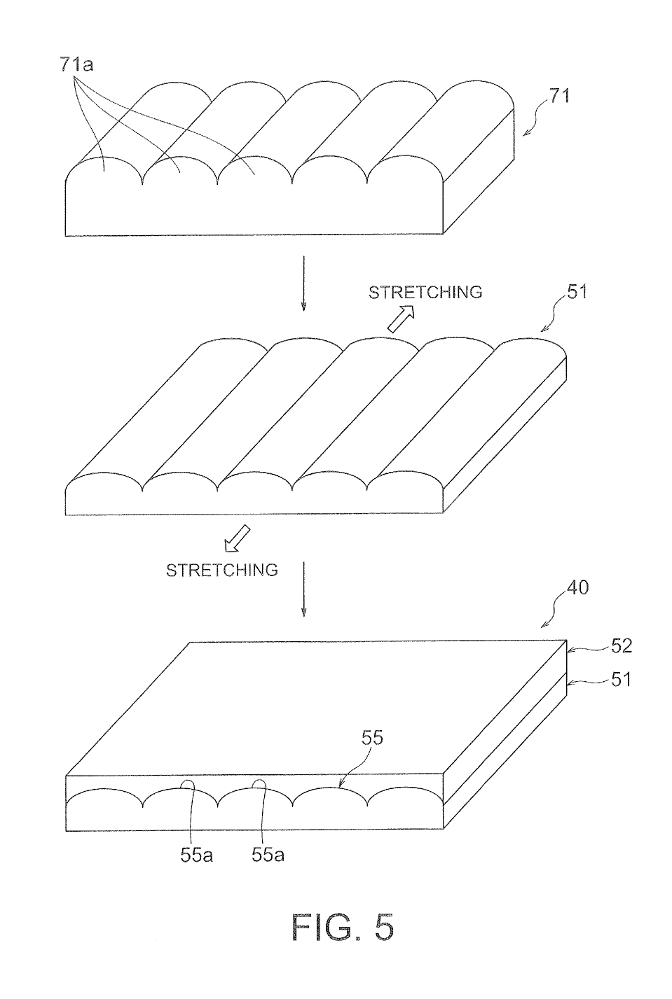

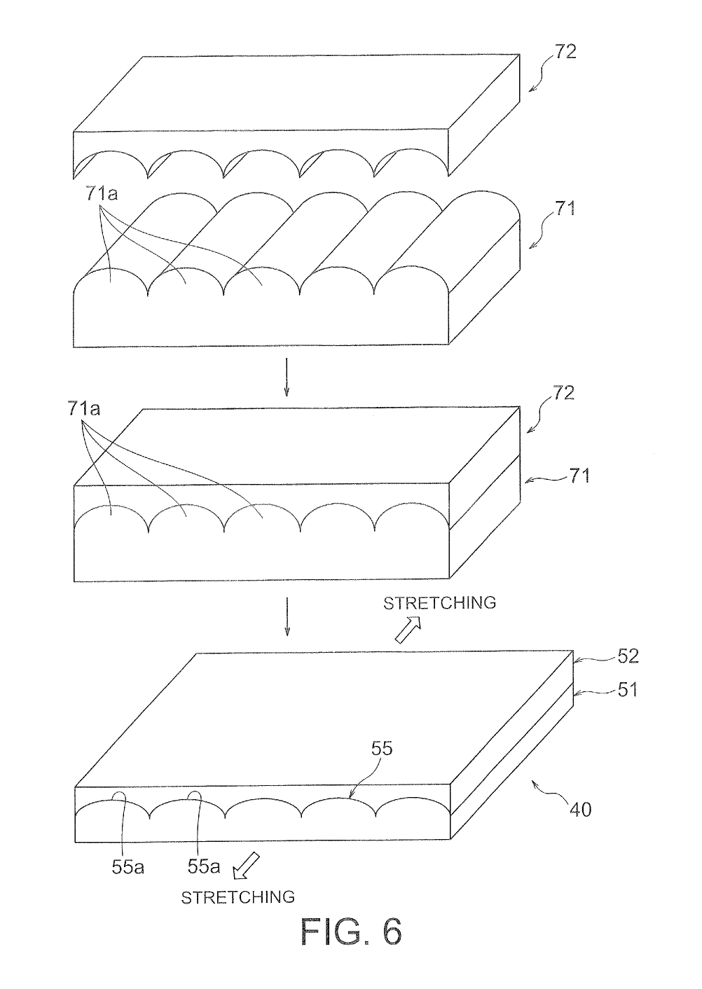

FIGS. 1 through 4 are diagrams illustrating an embodiment of the present invention. Of these, FIG. 1 is a perspective view showing a display device. FIGS. 2 and 3 are diagrams illustrating the actions of the display device when it displays a three-dimensional image and a two-dimensional image, respectively. FIG. 4 is a perspective view showing the refractive index ellipsoids of the first layer and the second layer of an optical sheet.

The display device 10 of this embodiment can switchably display a two-dimensional image and a naked-eye visible three-dimensional image. As shown in FIG. 1, the display device 10 includes an image display unit 15 and an optical sheet 40 which is disposed so as to face the image display unit 15. The image display unit 15 is configured to emit light of one linear polarization component for forming a three-dimensional image and light of the other linear polarization component for forming a two-dimensional image. The optical sheet 40 controls the traveling direction of light depending on the polarization state of the light. More specifically, the optical sheet 40 controls the traveling direction of light of the one linear polarization component for forming a three-dimensional image while maintaining the traveling direction of light of the other linear polarization component that vibrates in a direction perpendicular to the direction of vibration of the one linear polarization component.

The “two-dimensional image” herein refers to an image which is viewed two-dimensionally on a display surface 10a, while the “three-dimensional image” refers to an image having a sense of depth, which can be viewed also at a position at a distance from the display surface 10a. The display device 10 of this embodiment is configured to be capable of displaying a three-dimensional image by utilizing binocular parallax and motion parallax. As shown in FIG. 2, when displaying a three-dimensional image, the pixels 21 of the image forming device 20 of the image display unit 15 are assigned to those positions where the left eye or the right eye of a viewer is supposed to be located. Those pixels 21 which are assigned to the same position form an image to be viewed from the assigned position. The optical sheet 10, on the other hand, controls the path of light so that light, emitted from each pixel 21, travels toward the position to which the pixel 21 is assigned of those positions at which the left eye or the right eye of a viewer is supposed to be located. Accordingly, the viewer's left and right eyes view different images, and the viewer perceives a three-dimensional image. When the viewer changes the viewing direction, the viewer can view a different three-dimensional image according to the viewing position.

The components of the display device 10 will now be described in greater detail. In the following description, one linear polarization component that forms a three-dimensional image will be referred to as “first polarization component” that vibrates in the x-axis direction (see FIG. 1) parallel to the sheet plane of the optical sheet 40. The other linear polarization component that forms a two-dimensional image will be referred to as “second polarization component” that vibrates in the y-axis direction (see FIG. 1) perpendicular to the x-axis direction and parallel to the sheet plane of the optical sheet 40.

The terms “sheet”, “film” and “plate” are not used herein to strictly distinguish them from one another. Thus, the term “film” includes a member which can also be called a sheet or plate. An “optical sheet” is not strictly distinguished from a member called “optical film” or “optical plate”.

The term “sheet plane (film plane, plate plane, panel plane)” herein refers to a plane which coincides with the planar direction of an objective sheet-like (film-like, plate-like, panel-like) member when taking a wide and global view of the sheet-like (film-like, plate-like, panel-like) member. In this embodiment the image forming surface 20a of the image forming device 20, the panel plane of the liquid crystal display panel 25, the panel plane of the polarization control device 30, the sheet plane of the optical sheet 40 and the display surface 10a of the display device 10 are parallel to each other. The term “front direction” herein refers to the normal direction of the sheet plane of the optical sheet 40.

The terms used herein to specify shapes or geometric conditions, such as “parallel”, “perpendicular”, etc., should not be bound to their strict sense, and should be construed to include equivalents or resemblances from which the same optical function or effect can be expected.

The image display unit 15 includes the image forming device 20 and the polarization control device 30 which transmits light from the image forming device 20. The polarization control device 30 is disposed between the image forming device 20 and the optical sheet 40. The image forming device 20 has a large number of pixels 21 arranged in a plane parallel to the image forming surface 20a. In the illustrated embodiment, the pixels 21 are arranged in a stripe arrangement. The following description illustrates an exemplary case where the image forming device 20 forms an image by using light of the first polarization component. In this case, the polarization control device 30 maintains the first polarization state of light, emitted from the image forming device 20, when a three-dimensional image is to be displayed, or converts the polarization state of the light into the second polarization state when a two-dimensional image is to be displayed. However, it is also possible for the image forming device 20 to emit light of the second polarization component, and for the polarization control device 30 to convert the polarization state of light, emitted from the image forming device 20, into the first polarization state when a three-dimensional image is to be displayed, or maintains the second polarization state of the light when a two-dimensional image is to be displayed.

In the illustrated embodiment, the image forming device 20 is constructed as a liquid crystal display device. Thus, the image forming device 20 includes a liquid crystal display panel 25 and a backlight 24 disposed at the rear of the liquid crystal display panel 25. The backlight 24 may have any known construction, including that of the edge-light type or the direct-light type.

The liquid crystal display panel 25 includes a pair of polarizing plates 26, 28 and a liquid crystal cell 27 disposed between the polarizing plates 26, 28. The polarizing plates 26, 28 include polarizers which function to resolve incident light into two orthogonal polarization components, and transmit one polarization component and absorbs the other polarization component perpendicular to the one polarization component. In this embodiment the lower polarizing plate 26, disposed on the backlight 24 side, transmits light of the second polarization component, while the upper polarizing plate 28, disposed on the polarization control device 30 side, transmits light of the first polarization component.

The liquid crystal cell 27 includes a pair of support plates and liquid crystal molecules (liquid crystal material) disposed between the support plates. An electric field can be applied to each pixel area of the liquid crystal cell 27. When an electric filed is applied to a pixel area, the orientation of the liquid crystal of the liquid crystal cell 27 changes in the pixel area. For example, light of the second polarization component, which has passed through the lower polarizing plate 26, turns its vibration direction by 90 degrees when it passes through those pixel areas of the liquid crystal cell 27 to which an electric field is being applied, whereas light of the second polarization component maintains its polarization state when it passes through those pixel areas of the liquid crystal cell 27 to which no electric field is being applied. Thus, transmission through or absorption and blocking by the upper polarizing plate 28, disposed on the light exit side of the lower polarizing plate 26, of light of the second polarization component, which has passed through the lower polarizing plate 26, can be controlled by application or no application of an electric field to each pixel area of the liquid crystal cell 27. Light of the first polarization component, which has thus selectively passed through the upper polarizing plate 28 and has been emitted from pixels 21, will form an image.

The polarization control device 30 will now be described. The polarization control device 30 basically comprises a pair of a first electrode 34 and a second electrode 36, and a medium layer 35 disposed between the first electrode 34 and the second electrode 36. The medium layer 35 generates refractive index anisotropy when a voltage is applied between the pair of the electrodes 34, 36. In the illustrated embodiment, the first electrode 34, the medium layer 35 and the second electrode 36 are disposed between a pair of a first support film 33 and a second support film 37. The first electrode 34, the medium layer 35 and the second electrode 36 are supported and protected by the pair of the support films 33, 37. The following description illustrates a case where the medium layer is constructed as a liquid crystal layer 35.

The pair of electrodes 34, 36 and the liquid crystal layer 35 have a size that expands the entire area of the image forming surface 20a of the image forming device 20. As shown in FIGS. 2 and 3, the liquid crystal layer 35 contains liquid crystal molecules 31. The electrodes 34, 36 are electrically connected to a not-shown voltage application means. The electrodes 34, 36 are kept at a predetermined distance from each other e.g. by the use of a spacer (not shown).

When the liquid crystal molecules 31 contained in the liquid crystal layer 35 are typical liquid crystal molecules of the TN type, the liquid crystal molecules 31 are aligned when a voltage is applied between the pair of electrodes 34, 36, as shown in FIG. 2. The first polarization state of light (first polarization component) from the image forming device 20 is maintained upon passage of the light through the liquid crystal layer 35 to which a voltage is being applied. On the other hand, when no voltage is applied between the pair of electrodes 34, 36, the liquid crystal molecules 31 are in a 90 degree-twisted or turned state as shown in FIG. 3. When light from the image forming device 20 passes through the liquid crystal layer 35 to which no voltage is being applied, the vibration direction of the light is converted from the x-axis direction to the y-axis direction, i.e. the light is converted from the first polarization component to the second polarization component.

The above description of the image display unit 15, the image forming device 20 and the polarization control device 30 is merely exemplary. Thus, for example, it is also possible to generate light of the first polarization component by turning the vibration direction of light from the image forming device 20 by 45 degrees, and to generate light of the second polarization component by turning the vibration direction of light from the image forming device 20 by −45 degrees.

The optical sheet 40 will now be described. As shown in FIGS. 1 through 3, the optical sheet 40 includes a first layer 51 and a second layer 52 provided adjacent to the first layer 51. In the illustrated embodiment, the optical sheet 40 further includes a film layer 43 provided on the second layer 52.

The film layer 43 may be formed as a single layer or as a stack of multiple layers. The film layer 43 is expected to exert a particular function, and forms the outermost light exit-side surface of the display device 10, i.e. the display surface 10a of the display device 10. The film layer 43 may comprise at least one of an antireflective layer (AR layer) having an antireflective function, an anti-glare layer (AG layer) having an anti-glare function, an abrasive-resistant hard coat layer (HC layer), an antistatic layer (AS layer) having an antistatic function, etc.

The interface between the first layer 51 and the second layer 52 is formed as a surface having a three-dimensional (corrugated) pattern. The interface serves as an optical interface 55 which changes the traveling direction of light of at least the first polarization component. In the illustrated embodiment, the optical interface 55 between the first layer 51 and the second layer 52 is constructed as a surface consisting of a plurality of unit optical interfaces 55a. As shown in FIG. 1, the unit optical interfaces 55a are arranged in an arrangement direction. Each unit optical interface 55a extends in a direction not parallel to the arrangement direction. Particularly in the illustrated embodiment, the unit optical interfaces 55a are arranged in the x-axis direction without any space between adjacent unit interfaces, and each unit optical interface 55a extends linearly in the y-axis direction. Each unit optical interface 55a has the same shape at varying positions along the y-axis direction. The unit optical interfaces 55a all have the same construction.

As described above, the unit optical interfaces 55a are designed so that light, emitted from each pixel 21, is directed to a predetermined position. In the illustrated embodiment, in a cross-direction parallel to both the front direction and the arrangement direction of the unit optical interfaces 55a, each unit optical interface 55a has a convex lens-like contour and focuses a divergent light flux LF1 (see FIG. 2) from each pixel on a preset position. The optical interface 55 as an assembly of the unit optical interfaces 55a forms a lenticular lens.

The unit optical interfaces 55a and the optical interface 55, shown in the Figures, are merely examples and are capable of various changes and modifications. For example, the cross-sectional contour of each unit optical interface 55a may be arbitrarily changed. Further, the unit optical interfaces 55a may have different shapes. For example, the optical interface 55 may form a Fresnel lens. Though the illustrated unit optical interfaces 55a are composed of elongated elements arranged one-dimensionally, the unit optical interfaces 55a may be arranged two-dimensionally.

The refractive indices of the first layer 51 and the second layer 52 will now be described. The first layer 51 is optically anisotropic, and is birefringent at least in a plane. Thus, the refractive index n₁ₓ of the first layer 51 in the x-axis direction differs from the refractive index n_{1y} of the first layer 51 in the y-axis direction. In addition, in the optical sheet 40 of this embodiment, the refractive index n₁ₓ of the first layer 51 in the x-axis direction, the refractive index n₂ₓ of the second layer 52 in the x-axis direction, the refractive index n_{1y} of the first layer 51 in the y-axis direction and the refractive index n_{2y} of the second layer 52 in the y-axis direction satisfy the following relation:

|n₁ₓ−n₂ₓ|≠|n_{1y}−n_{2y}|

Accordingly, the optical sheet 40 exerts different optical effects on light of the first polarization component that vibrates in the x-axis direction and light of the second polarization component that vibrates in the y-axis direction. In particular, light of the first polarization component and light of the second polarization component, both traveling in the same direction, come to travel in different directions after passing through the optical interface 55 of the optical sheet 40.

Particularly in this embodiment the following relation is satisfied:

|n₁ₓ−n₂ₓ|>|n_{1y}−n_{2y}|=0

In this case, the optical interface 55 of the optical sheet 40 no more functions as an effective optical interface, having a refractive index difference, on light of the second polarization component that vibrates in the y-axis direction. Thus, while the optical interface 55 of the optical sheet 40 exerts an optical effect (e.g. lens effect) on light of the first polarization component, light of the second polarization component does not change its traveling direction when it passes through the optical interface 55 of the optical sheet 40. A refractive index value is herein expressed as a value rounded off to two decimal places.

In application of the optical sheet 40 in a display device which switchably displays a two-dimensional image and a naked-eye visible three-dimensional image, it is not practically essential for the refractive indices n_{1y}, n_{2y} to satisfy the relation: |n_{1y}−n_{2y}|=0, and it is sufficient if the following relation is satisfied:

|n₁ₓ−n₂ₓ|>|n_{1y}−n_{2y}| and |n_{1y}−n_{2y}|≦0.02

In this case, light of the second polarization component will not change its traveling direction at the optical interface 55 of the optical sheet 40 to such an extent as to cause problems, such as ghost and crosstalk.

In application of the optical sheet 40 in a display device which switchably displays a two-dimensional image and a naked-eye visible three-dimensional image, the level of the optical effect, exerted on light of the second polarization component, is affected not only by the absolute value of |n_{1y}−n_{2y}| but also by other factors, including the shape of the optical interface 55 of the optical sheet 40, as will be described in detail below. From the above viewpoint, the optical sheet 40 may be designed so that light of the polarization component (second polarization component) that vibrates in the y-axis direction, traveling in a direction perpendicular to the sheet plane of the optical sheet 40, i.e. in the front direction, before entering the optical sheet 40, comes to travel in a direction at an angle of not more than 2 degrees with respect to the front direction after passing through the optical sheet 40. This can effectively prevent an optical effect which could cause image degradation e.g. upon display of a two-dimensional image, due to the occurrence of a problem such as ghost, from being exerted on light of the second polarization component, passing though the optical sheet 40.

FIG. 4 shows exemplary refractive index ellipsoids that indicate refractive index distributions in the first layer 51 and the second layer 52 in varying directions. In the illustrated embodiment the following relation is satisfied:

(n₁ₓ−n₂ₓ)>|n_{1y}−n_{2y}|=0

The refractive index n₁ₓ of the first layer 51 in the x-axis direction is higher than the refractive index n_{1y} of the first layer in the y-axis direction. Further, in the embodiment illustrated in FIG. 3, the second layer 52 is formed as an optically isotropic layer. Thus, the refractive index n₂ₓ of the second layer 52 in the x-axis direction is equal to the refractive index n_{2y} of the second layer 52 in the y-axis direction. Therefore, the refractive index n₁ₓ of the first layer 51 in the x-axis direction is higher than the refractive index n₂ₓ of the second layer 52 in the x-axis direction. Accordingly, the optical interface 55 shown in FIG. 1 can exert the same lens effect as a convex lens.

In the embodiment illustrated in FIG. 1, the direction of the slow axis, in which the refractive index is maximum, coincides with the x-axis direction in a plane in the first layer 51, while the direction of the fast axis, in which the refractive index is minimum, coincides with the y-axis direction in a plane in the first layer 51. In addition, the refractive index n_{1y} in the y-axis direction (direction of the fast axis) in a plane in the first layer 51 is made equal to the refractive index n_{2y} in the y-axis direction in a plane in the second layer 52. Therefore, the difference in the x-axis direction refractive index between the first layer 51 and the second layer 52 can be set to be large while setting the difference in the y-axis direction refractive index between the first layer 51 and the second layer 52 to zero. In application of the optical sheet 40 in a home display device, on the condition that the optical interface 55 is manufactured in a shape easy to manufacture, the birefringent index Δn (=n₁ₓ−n_{1y}) of the first layer 51 is preferably not less than 0.13. On the other hand, when the optical anisotropy of the first layer 51 is provided by stretching as described below, the birefringent index Δn of the first layer 51 is preferably not more than 0.22 e.g. in view of the in-plane uniformity in a stretching process.

The refractive indices of the first layer 51 and the second layer 52 can be measured, for example, by using “KOBRA-WR” manufactured by Oji Scientific Instruments, “Ellipsometer M150” manufactured by JASCO Corporation, or an Abbe refractometer (NAR-4, manufactured by Atago Co., Ltd.).

Such an optical sheet 40 can be produced in the following manner: First, as shown in FIG. 5, a resin film 71 is produced by using a thermoplastic resin. Thereafter, the resin film 71 is subjected to stretching to produce a first layer 51 composed of the stretched resin film 71. Thereafter, a second layer 52 is formed on the first layer 51 to obtain an optical sheet 40.

The resin film 71 can be produced by molding of a resin material comprising a thermoplastic resin as a main component, or consisting only of a thermoplastic resin. The molding of the resin material may be performed by injection molding or melt extrusion. Such a molding method can produce the resin film 71 having a three-dimensional (corrugated) pattern that forms the optical interface 55. As shown in FIG. 5, the resin film 71 has raised portions 71a arranged in a direction not parallel to the longitudinal direction of each raised portion 71a.

A mold, having a mold surface made of metal or plastic, can be used for the molding of the resin film 71. Compared to the use of a mold having a metal mold surface, the use of a mold having a plastic mold surface can prevent rapid absorption of heat from a heated thermoplastic resin into the mold surface upon application of the thermoplastic resin onto the mold surface. This enables the heated thermoplastic resin to fully spread over the mold surface, making it possible to enhance the rate of shaping. Further, the resin film 71 produced can be easily released from the mold surface. This can prevent the formation of a defect in the resin film 71 upon its release from the mold surface. A long film-like mold can be used as a mold having a plastic mold surface.

Stretching of the resin film 71 is performed in order to impart optical anisotropy to the resin film 71 and, insofar as this object is achieved, may be performed by any of uniaxial stretching, sequential biaxial stretching and simultaneous biaxial stretching. When the resin film 71 comprises a polyester resin, the stretching direction (stretching axis) coincides with the slow axis. For example, when it is intended to make the longitudinal direction of the unit optical interfaces 55a parallel to the slow axis of the first layer 51, the resin film is stretched in a direction parallel to the longitudinal direction of the raised portions of the resin film 71 which are to form the unit optical interfaces 55a of the optical interface 55, as shown in FIG. 5.

Stretching of the resin film 71 is carried out while heating the resin film 71 at a temperature above the glass transition temperature of the thermoplastic resin of the resin film 71. In the case where the resin film 71 is produced by melt extrusion, the high-temperature resin film 71 immediately after extrusion may be subjected to stretching. Thus, there is no need to separately provide a heating process for stretching of the resin film 71. As shown in FIG. 5, the shape of the resin film 71 is changed by stretching to form the first layer 51. Therefore, in the molding of the resin film 71, the resin film 71 is produced in a shape that takes into account the deformation of the resin film 71 by stretching.

Next, the second layer 52 is formed on the first layer 51 by applying a resin onto the first layer 51 and curing the resin on the first layer 51. The second layer 52, thus formed on the first layer 51, has a three-dimensional pattern, corresponding to or complementary to the three-dimensional (corrugated) pattern of the first layer 51, in the surface facing the first layer 51. Alternatively, a second layer 52, which has been produced separately, may be laminated to the first layer 51. A resin material for the second layer 52 may be a thermoplastic, thermosetting or ionizing radiation-curable resin which is non-birefringent, i.e. having an isotropic refractive index (n₂ₓ=n_{2y}). The optical sheet 40 can be produced in the above manner. Such a non-birefringent resin for the second layer 52 is usually solidified in the unstretched state.

The optical sheet 40 can also be produced by a production method as illustrated in FIG. 6.

In the production method illustrated in FIG. 6, a resin film 71 having the above-described three-dimensional (corrugated) pattern (see FIG. 5) and a second rein film 72 having a three-dimensional pattern corresponding to, or complementary to the three-dimensional (corrugated) pattern of the resin film 71 are prepared first. Next, the resin film 71 and the second resin film 72 are laminated to each other e.g. with an adhesive or glue in such a manner that the respective three-dimensional patterns engage each other. Thereafter, the laminate of the resin film 71 and the second resin film 72 are stretched e.g. in the longitudinal direction of each raised portion 71a of the resin film 71 to obtain an optical sheet 40 consisting of the first layer 51 composed of the resin film 71 and the second layer 52 composed of the second resin film 72.

Also in the production method illustrated in FIG. 6, the resin film 71 and the second resin film 72 can be produced by molding using a thermoplastic resin as in the above-described production method illustrated in FIG. 5. Also in the production method illustrated in FIG. 6, in-plane birefringence is imparted to the resin film 71 by stretching of the resin film 71. Though the second resin film 72 is also stretched together with the resin film 71, it is not necessary to intentionally impart optical anisotropy to the second resin film 72. Therefore, in order to prevent in-plane birefringence from being produced in the second resin film 72, the electric dipole moment of a molecule in the second resin film 72 is preferably low. In particular, the electric dipole moment of a molecule in the second resin film 72 is preferably at least lower than the electric dipole moment of a molecule in the resin film 71. The measurement of the electric dipole moment of a film can be performed by first measuring the dielectric constant of the film with a test fixture HP 16451B electrode of precision LCR meter, manufactured by Yokogawa-Hewlett-Packard Ltd., and then determining the electric dipole moment using the measured dielectric constant.

The level of birefringence (refractive index anisotropy) produced in a film depends on the electric dipole moment of the constituent molecule of the film. Accordingly, by using the resin film 71 and the second resin film 72 which satisfy the above relation in the electric dipole moments of the respective constituent molecules, the following relation is satisfied even when the resin film 71 and the second resin film 72 are stretched to the same extent to cause the same degree of molecular alignment in the films:

birefringent index Δₙ₁ of the resin film 71>birefringent index Δₙ₂ of the second resin film 72 or, when expressed with the refractive indices of the films in the x- and y-axis directions, n₁ₓ−n_{1y}>n₂ₓ−n_{2y} (ideally→0).

The optical sheet 40 consisting of the optically anisotropic first layer 51 comprising a thermoplastic resin, and the second layer 52 which is laminated to the first layer 51 and which forms, between it and the first layer 52, the optical interface 55 for changing the traveling direction of light of the first polarization component, can thus be produced.

A polycarbonate resin, a cycloolefin polymer resin, an acrylic resin, a polyester resin, etc. can be used as the thermoplastic resin of the first layer 51. Of these, a polyester resin is advantageous in terms of cost and mechanical strength. Specific examples of the polyester resin include polyethylene naphthalate, polyethylene terephtha late, polyethylene isophtha late, polybutylene terephtha late, poly(1, 4-cyclohexylene dimethylene terephthalate), and polyethylene-2, 6-naphthalate. The polyester resin, forming the first layer 50, may be a copolymer of such a polyester resin or a resin blend of a major amount (e.g. not less than 80 mol %) of such a polyester resin and a minor amount (e.g. not more than 20 mol %) of other resin(s). Of the above polyester resins, polyethylene naphthalate is preferred because it can ensure a high birefringent index. Of the above polyester resins, polyethylene terephthalate or polyethylene-2, 6-naphthalate is preferred because of good balance between mechanical properties and optical properties. From the viewpoint of stability of the optical sheet 40, the glass transition temperature of the material of the first layer 51 is preferably not less than 100° C.

The display device 10, which includes such an optical sheet 40, can display a two-dimensional image and a naked-eye visible three-dimensional image in the following manner. The case of displaying a two-dimensional image will be described first mainly with reference to FIG. 3.

The backlight 24 illuminates an area of the liquid crystal display panel 25 from the back. The liquid crystal display panel 25 transmits light from the backlight 24 selectively for each pixel 21. Two-dimensional image lights L31 to L36 thus formed, exiting the image forming surface 20a of the image forming device 20, are of the first polarization component that can pass through the upper polarizing plate 28 of the image forming device 20. The two-dimensional image lights L31 to L36 then enter the polarization control device 30. When displaying a two-dimensional image, no voltage is applied between the pair of electrodes 34, 36 of the polarization control device 30. The liquid crystal molecules 31 are therefore in a 90 degree-turned state as shown in FIG. 3. Accordingly, the two-dimensional image lights L31 to L36 passing through the polarization control device 30 change their polarization state, and have turned into the second polarization component when exiting the image display unit 15.

The two-dimensional image lights L31 to L36 that have exited the image display unit 15 enter the optical sheet 40. The optical sheet 40 has the optical interface 55 which is formed as a corrugated surface. The optical interface 55 is formed between the optically anisotropic first layer 51 and the second layer 52. The refractive index n_{1y} of the first layer 51 in the y-axis direction, i.e. in the vibration direction of the two-dimensional image lights L31 to L36 of the second polarization component, is set equal to the refractive index n_{2y} of the second layer 52 in the y-axis direction. The two-dimensional image lights L31 to L36 therefore travel in the optical sheet 40 without changing their travelling directions at the optical interface 55. The two-dimensional image lights L31 to L36 then exit the display surface 10a of the display device 10, whereby a viewer can view a two-dimensional image.

Light from the backlight 24, illuminating the liquid crystal display panel 25, has a light axis in the front direction (i.e. has the peak of brightness in the front direction), while the light travels in a direction with a certain angular range around the front direction. Therefore, light that has passed through each pixel 21 travels and exits the display surface 10a of the display device 10 as divergent light in a certain angular range. Accordingly, as shown in FIG. 3, a viewer can view the same two-dimensional image, formed on the display surface 10a, in a certain angular range.

The case of displaying a three-dimensional image that can be viewed with the naked eye will now be described with reference to FIG. 2. As with the case of displaying a two-dimensional image, three-dimensional image lights Ll1 to Ll6, Lr1 to Lr6 exit the image forming device 20. The three-dimensional image lights Ll1 to Ll6, Lr1 to Lr6 then enters the polarization control device 30. When displaying a three-dimensional image, each pixel 21 of the image forming device 20 of the image display unit 15 is assigned to one of those positions where the left eye or the right eye of a viewer is supposed to be located. The image display unit 15 controls transmission and blocking of light for each pixel 21 so that an image is formed by lights from those pixels 21 which are assigned to the same position.

As shown in FIG. 2, when displaying a three-dimensional image, a voltage is applied between the electrodes 34, 36 of the polarization control device 30. Accordingly, the three-dimensional image lights Ll1 to Ll6, Lr1 to Lr6 pass through the polarization control device 30 while maintaining their first polarization state.

The three-dimensional image lights Ll1 to Ll6, Lr1 to Lr6 that have exited the image display unit 15 enter the optical sheet 40. The refractive index n₁ₓ of the first layer 51 in the x-axis direction, i.e. in the vibration direction of the three-dimensional image lights Ll1 to Ll6, Lr1 to Lr6 of the first polarization component, is made higher than the refractive index n₂ₓ of the second layer 52 in the x-axis direction. The optical interface 55 of the optical sheet 40 thus controls the traveling direction of the three-dimensional image lights Ll1 to Ll6, Lr1 to Lr6 from the pixels 21.

As described above, a divergent light flux from each pixel 21 enters the optical sheet 40. The unit optical interfaces 55a of the optical interface 55 each exert a lens effect and focus a divergent light flux from each pixel 21 on a position corresponding to the focal point of each optical interface 55a that functions as a lens. In particular, each unit optical interface 55a focuses a divergent light flux (e.g. divergent light flux LF1 shown in FIG. 2), emitted from a pixel 21 located opposite to the unit optical interface 55a, on a position to which the pixel 21 is assigned, i.e. one of those positions where the left eye or the right eye of a viewer is supposed to be located. The three-dimensional image lights Ll1 to Ll6, Lr1 to Lr6 from the pixels 21 thus travel toward their respective scheduled positions.

When a viewer views the display device 10 from a supposed position, an image to be viewed from the position of the right eye of the viewer can be viewed by the right eye, while an image to be viewed from the position of the left eye of the viewer can be viewed by the left eye. The viewer can therefore view a three-dimensional image with the naked eye by binocular parallax. When a viewer views the display device 10 from another supposed position as shown in FIG. 2, an image to be viewed from that position can be viewed three-dimensionally with the naked eye. Thus, when the viewer changes the viewing direction, the viewer can view different images with the naked eye according to the viewing directions. Thus, the viewer can view an image with a higher stereoscopic effect by motion parallax.

In a conventional display device for switchably displaying a two-dimensional image and a naked-eye visible three-dimensional image, a birefringent lens having an optically anisotropic layer containing liquid crystal (liquid crystal molecules, liquid crystal material) is used to control the traveling direction of light depending on the polarization state of the light. The optically anisotropic layer is typically produced by curing an ultraviolet curable resin containing liquid crystal.

The optically anisotropic layer of the conventional birefringent lens contains a high proportion of liquid crystal and has a large thickness of e.g. more than 5 μm in order to ensure a sufficiently high birefringent index. Because of the high content of liquid crystal, the conventional birefringent lens lacks stability, especially thermal stability. This imposes restrictions on the environment in which the birefringent lens and a display device having the birefringent lens are installed.

According to this embodiment, on the other hand, the first layer 51 of the optical sheet 40, having an in-plane birefringent index, contains no liquid crystal (liquid crystal molecules, liquid crystal material). Optical anisotropy is imparted to the first layer 51 by stretching of the first layer 51 composed of a thermoplastic resin. Accordingly, it is quite possible for the first layer 51 to have a glass transition temperature of not less than 100° C. The optical sheet 40 of this embodiment and the display device 10 incorporating the optical sheet 40 therefore exhibit excellent thermal stability. For example, compared to the conventional birefringent lens containing liquid crystal, the optical sheet 40 of this embodiment can dramatically improve dimensional stability as measured according to JIS C2151 using the heating conditions of 150° C., 30 minutes. Specifically, the dimensional stability value of the optical sheet 40 of this embodiment, measured according to JIS C2151 using the heating conditions of 150° C., 30 minutes, can be made as low as not more than 2%. The optical sheet 40 of this embodiment can therefore be used, without significant restriction on it, in a common environment where a home television receiver, for example, is used, and the optical sheet 40 can exert the expected optical effect.

Various changes and modifications may be made to the above-described embodiment. Some variations will now be described. In the following description, the same reference numerals are used for the same members or elements as used in the above-described embodiment, and a duplicate description thereof will be omitted.

The optical sheet 40 is merely an example and can be arbitrarily changed: The film layer 43 is not essential and may be omitted from the optical sheet 40. An additional film layer, which is expected to perform a certain function, may be provided at a position nearer to the polarization control device 30 than the first layer 51 and the second layer 52. As described above, the construction of the optical interface 55 and the unit optical interfaces 55a can be arbitrarily changed depending on a desired optical effect. Further, the optically anisotropic first layer 51 may be disposed nearer to the viewer than the second layer 52.

The above-described relation between the refractive index n₁ₓ of the first layer 51 in the x-axis direction, the refractive index n_{1y} of the first layer 51 in the y-axis direction, the refractive index n₂ₓ of the second layer 52 in the x-axis direction and the refractive index n_{2y} of the second layer 52 in the y-axis direction is merely exemplary, and is not intended to limit the scope of the present invention.

In the above-described embodiment the refractive index difference between the first layer 51 and the second layer 52 is made zero in either one of the x-axis direction and the y-axis direction. However, it is possible to make the refractive index difference between the first layer 51 and the second layer 52 not zero in both of the x-axis direction and the y-axis direction. Also in this case, the same effect as described above can be obtained by appropriately designing the construction of the optical interface 55 and the unit optical interfaces 55a.

Though in the above-described embodiment the main axes (the slow axis and the fast axis) in a plane of the first layer 51 coincide with the directions of vibration of light that forms a three-dimensional image and light that forms a two-dimensional image, it is possible not to make the main axes coincide with the vibration directions. Also in this case, the same effect as described above can be obtained by appropriately adjusting the refractive indices n₁ₓ, n_{1y}, n₂ₓ and n_{2y}.

The modifications described above can of course be made in an appropriate combination to the above-described embodiment.

What is claimed is:

1. An optical sheet comprising:
a first layer including a thermoplastic resin, the first layer being optically anisotropic; and
a second layer which is laminated to the first layer and which forms, between it and the first layer, an optical interface for changing a traveling direction of light of one polarization component,
wherein the optical sheet controls a traveling direction of light depending on a polarization state of the light and is used in a display device for switchably displaying a two-dimensional image and a naked-eye visible three-dimensional image.

2. The optical sheet according to claim 1,
wherein a material of the first layer has a glass transition temperature of not less than 100° C.

3. The optical sheet according to claim 1,
wherein the thermoplastic resin is a polyethylene naphthalate resin.

4. The optical sheet according to claim 1,
wherein an in-plane birefringent index Δn of the first layer is not less than 0.13.

5. The optical sheet according to claim 1,
wherein light of the other polarization component, traveling in a normal direction of the optical sheet before entering the optical sheet, travels in a direction at an angle of not more than 2 degrees with respect to the normal direction of the optical sheet after passing through the optical sheet.

6. The optical sheet according to claim 1,
wherein a dimensional stability of the optical sheet, measured according to JIS C2151 using a heating conditions of 150° C., 30 minutes, is not more than 2%.

7. The optical sheet according to claim 1,
wherein the second layer is optically isotropic.

8. The optical sheet according to claim 1,
wherein an electric dipole moment of the first layer is higher than an electric dipole moment of the second layer.

9. A display device comprising:
the optical sheet according to claim 1; and
an image display unit disposed opposite to the optical sheet and configured to be capable of emitting light of one polarization component for forming a three-dimensional image and light of the other polarization component for forming a two-dimensional image,
wherein the display device switchably displays a two-dimensional image and a naked-eye visible three-dimensional image.
